(19) United States
(12) Patent Application Publication
(10) Pub. No.: US 2025/0056244 A1
(43) Pub. Date: Feb. 13, 2025

(54) COMMUNICATION FUNCTIONALITY VALIDATION

(71) Applicant: Nokia Technologies Oy, Espoo (FI)

(72) Inventors: Fahad SYED MUHAMMAD, Orsay (FR); Tachporn SANGUANPUAK, Oulu (FI); Frederick VOOK, Schaumburg, IL (US); Amir Mehdi AHMADIAN TEHRANI, Munich (DE); Dimitri GOLD, Espoo (FI); Andrea BONFANTE, Paris (FR)

(21) Appl. No.: 18/797,517

(22) Filed: Aug. 8, 2024

Related U.S. Application Data
(60) Provisional application No. 63/518,813, filed on Aug. 10, 2023.

(51) Int. Cl. H04W 16/28; H04W 16/18

(52) U.S. Cl. CPC H04W 16/28; H04W 16/18

(57) ABSTRACT

Embodiments of the present disclosure relate to apparatuses, methods, devices and computer readable storage medium for communication functionality validation. In a method, a first apparatus receives, from a second apparatus, a first performance metric of a first outcome of a communication functionality based on a first set of communication parameters. The first apparatus receives, from the second apparatus, a reference performance metric of a reference outcome of the communication functionality based on a set of reference communication parameters. The first apparatus validates the communication functionality based on a threshold and a first difference between the first performance metric and the reference performance metric.

### FIELDS

Various example embodiments of the present disclosure generally relate to the field of telecommunication and in particular, to apparatuses, methods, devices and computer readable storage medium for communication functionality validation.

### BACKGROUND

Several technologies have been proposed to improve communication performances. For example, communication devices may employ an artificial intelligence (AI)/ML model to improve communication qualities. The AI/ML model can be applied to different communication functionality in different scenarios. Therefore, performances of an AI/ML based communication functionality are an importance issue.

### SUMMARY

In a first aspect of the present disclosure, there is provided a first apparatus. The first apparatus comprises at least one processor; and at least one memory storing instructions that, when executed by the at least one processor, cause the first apparatus to: receive, from a second apparatus, a first performance metric of a first outcome of a communication functionality based on a first set of communication parameters; receive, from the second apparatus, a reference performance metric of a reference outcome of the communication functionality based on a set of reference communication parameters; and validate the communication functionality based on a threshold and a first difference between the first performance metric and the reference performance metric.

In a second aspect of the present disclosure, there is provided a second apparatus. The second apparatus comprises at least one processor; and at least one memory storing instructions that, when executed by the at least one processor, cause the second apparatus to: transmit, to a first apparatus, a first performance metric of a first outcome of a communication functionality based on a first set of communication parameters; and transmit, to the first apparatus, a reference performance metric of a reference outcome of the communication functionality based on a set of reference communication parameters.

In a third aspect of the present disclosure, there is provided a method. The method comprises: receiving, at a first apparatus from a second apparatus, a first performance metric of a first outcome of a communication functionality based on a first set of communication parameters; receiving, from the second apparatus, a reference performance metric of a reference outcome of the communication functionality based on a set of reference communication parameters; and validating the communication functionality based on a threshold and a first difference between the first performance metric and the reference performance metric.

In a fourth aspect of the present disclosure, there is provided a method. The method comprises: transmitting, at a second apparatus to a first apparatus, a first performance metric of a first outcome of a communication functionality based on a first set of communication parameters; and transmitting, to the first apparatus, a reference performance metric of a reference outcome of the communication functionality based on a set of reference communication parameters.

In a fifth aspect of the present disclosure, there is provided a first apparatus. The first apparatus comprises means for receiving, from a second apparatus, a first performance metric of a first outcome of a communication functionality based on a first set of communication parameters; means for receiving, from the second apparatus, a reference performance metric of a reference outcome of the communication functionality based on a set of reference communication parameters; and means for validating the communication functionality based on a threshold and a first difference between the first performance metric and the reference performance metric.

In a sixth aspect of the present disclosure, there is provided a second apparatus. The second apparatus comprises means for transmitting, to a first apparatus, a first performance metric of a first outcome of a communication functionality based on a first set of communication parameters; and means for transmitting, to the first apparatus, a reference performance metric of a reference outcome of the communication functionality based on a set of reference communication parameters.

In a seventh aspect of the present disclosure, there is provided a computer readable medium. The computer readable medium comprises instructions stored thereon for causing an apparatus to perform at least the method according to the third aspect or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example block diagram for communication functionality validation according to some example embodiments of the present disclosure;

FIG. 3 illustrates an example signaling chart for communication functionality validation according to some example embodiments of the present disclosure;

FIG. 4 illustrates an example process for communication functionality validation according to some example embodiments of the present disclosure;

FIG. 5 illustrates a flowchart of a method implemented at a first apparatus according to some example embodiments of the present disclosure;

FIG. 6 illustrates a flowchart of a method implemented at a second apparatus according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “AI/ML model” may refer to a data driven algorithm that applies AI/ML techniques to generate a set of outputs based on a set of inputs. In the context of the present disclosure, the term “AI/ML model” may be used interchangeably with the terms “model”, “AI model” and “ML model”. The term “AI/ML” may be used interchangeably with the terms “AI” and “ML”.

As used herein, the term “generalization” refers to the model's ability to adapt properly to new, previously unseen data. The new or previously unseen data may be drawn from a distribution different from the one used to create or train the model. In other words, generalization examines how well a model can digest new data (mostly corresponding to new environment/scenario) and make correct predictions (for unseen/new environment or scenario) after getting trained on a training set.

As described above, AI/ML for New Radio (NR) air interface is now studied in 3rd Generation Partnership Project (3GPP). One of the objectives of the study is to cover the interoperability and testability aspect of the newly defined AI/ML enabled features. In this aspect, studies on use case may include for example requirements and testing frameworks to validate AI/ML based performance enhancements, ensuring that UE and gNB with AI/ML meet or exceed the existing minimum requirements if applicable, considering the need and implications for AI/ML processing capabilities definition.

If a model is trained too well on training data, it will be incapable of generalizing. In such cases, the model will end up making erroneous predictions when it's given new data. This would make the model ineffective even though it's capable of making correct predictions for the training data set. Such model trained too well may be referred to as overfitting.

Several mechanisms have been proposed for avoiding the problem of overfitting and to keep good generalization capabilities of the model, such as dropOut, batch normalization, early stopping, etc. For example, the following cases may be considered for verifying the generalization performance of an AI/ML model over various scenarios/configurations. An example case (referred to as Case 1) may be that the AI/ML model is trained based on training dataset from one Scenario #A/Configuration #A, and then the AI/ML model performs inference/test on a dataset from the same Scenario #A/Configuration #A. Another example case (referred to as Case 2) may be that the AI/ML is model trained based on training dataset from one Scenario #A/Configuration #A, and then the AI/ML model performs inference/test on a different dataset than Scenario #A/Configuration #A, e.g., Scenario #B/Configuration #B, Scenario #A/Configuration #B. A further example case (referred to as Case 3) may be that the AI/ML model is trained based on training dataset constructed by mixing datasets from multiple scenarios/configurations including Scenario #A/Configuration #A and a different dataset than Scenario #A/Configuration #A, e.g., Scenario #B/Configuration #B, Scenario #A/Configuration #B, and then the AI/ML model performs inference/test on a dataset from a single Scenario/Configuration from the multiple scenarios/configurations, e.g., Scenario #A/Configuration #A, Scenario #B/Configuration #B, Scenario #A/Configuration #B. It is to be noted that the number of the multiple scenarios/configurations may be larger than two.

In some mechanisms, further cases for generalization verification may be optionally considered. For example, a case (referred to as Case 2A) may be that the AI/ML model is trained based on training dataset from one Scenario #A/Configuration #A, and then the AI/ML model is updated based on a fine-tuning dataset different than Scenario #A/Configuration #A, e.g., Scenario #B/Configuration #B, Scenario #A/Configuration #B. After that, the AI/ML model is tested on a different dataset than Scenario #A/Configuration #A, e.g., subject to Scenario #B/Configuration #B, Scenario #A/Configuration #B. The fine-tuning dataset setting (e.g., size of dataset) and the improvement of performance may be reported.

In brief, Case 1 focuses on training dataset from Scenario A/Configuration A and performing inference on the same Scenario/Configuration. Case 2 focuses on training dataset from Scenario A/Configuration A and performing inference on a different Scenario/Configuration. Case 2A investigates training on a selected Scenario A/Configuration A and generalizing to Scenario B/Configuration B via fine-tuning (e.g., transfer learning) as an evolved version of Case 2. Case 3 investigates using mixed training dataset on both Scenario A/Configuration A and Scenario B/Configuration B and test to any combination of Scenario A/Configuration A and Scenario B/Configuration B.

Several evaluation results show that Case 3 and/or Case 2A provides better performance than Case 2. In most of the cases/evaluations, Case 3 has performance degradation than Case 1. From the evaluation results for scenario with various UE distribution, Case 3 may have similar or slightly higher performance than Case 1.

For some cases, Case 2 has some performance degradation than Case 1 in most of the cases or evaluations. In Case 2, AI/ML still may provide better performance (e.g., greater than 30% of Top-1 beam prediction unless otherwise stated) than non-AI baseline option 2 (based on the measurements from Set B of beams).

For some cases, Case 2 has significant performance degradation than Case 1 in most of the cases or evaluations. In Case 2, AI/ML still may provide comparable or worse performance (e.g., less than 30% of Top-1 beam prediction unless otherwise stated) than non-AI baseline option 2 (based on the measurements from Set B of beams).

In some mechanisms, the following are assumed in the simulation unless otherwise stated. For DL Tx beam prediction, the measurements from best Rx beam are used. Fixed Set B pattern is used. The simulation is without UE rotation. Beams may be measured regardless of their signal to noise ratio (SNR). No measurement error is assumed. Measured in a single-time instance (within a channel-coherence time interval) is assumed. No quantization for the layer one (L1)-reference signal received power (RSRP) measurements is assumed. No constraint on uplink control information (UCI) payload overhead for full report of the L1-RSRP measurements of Set B for NW-side models are assumed.

These observations may be applicable for both Tx beam and beam pair. The evaluation results are from BM-Case 1 and similar observation are expected for BM-Case 1 when Set B is different from Set A.

The generalization of AI/ML models/functionality becomes one of the main challenges for the AI/ML enabled use cases. In practice, if a model has been trained for a given radio condition or a certain parameter setting then encountering a different radio condition or parameter settings, the performance of the functionality may be severely impacted.

However, no such test mechanism exists for generalization aspects validation of AI/ML based beam management use cases with impacts on specifications requirements (such as 3GPP) and impacts on user equipment (UE) and testing equipment (TE) interface. The network (NW) side and/or UE side model training as well as the model inference for AI is currently studied.

In some mechanisms, whether it is needed/feasible to introduce some form of generalization and/or scalability related requirements for different scenarios/configurations based on radio access network 1 (RAN1) agreements need to be considered. Whether this can be implicitly handled in the test case definition should be considered. Intention is to guarantee that performance will still be maintained in different environments/scenarios/configurations.

In some mechanisms, AI/ML requirements may be defined for the cases with the existing legacy performance. The legacy performance may be taken as baseline for existing use cases/procedures/functionalities/measurements that are to be enhanced by AI/ML based methods.

The necessity and feasibility of defining requirements or test to verify the generalization of AI/ML need to be considered. The AI/ML model may be a one-side model and/or two-side model.

In some mechanisms, if the configured AI/ML functionality/model has been trained with a dataset representing mainly then this AI/ML functionality/model may experience degraded performance if different channel conditions are met in the field. To avoid performance degradation, it should be guaranteed that the AI/ML configured functionality/model has been trained with a diverse dataset and can perform well with acceptable tolerance margin in varying channel conditions. This should also be verified in radio access network 4 (RAN4) testing in order to completely validate the configured AI/ML functionality/model.

To sum up, verification of generalization is becoming an important topic in RAN4 discussions as well for AI/ML enabled use cases. However, currently, there is no such test mechanism that can validate generalization aspects of AI/ML enabled functionalities.

According to some example embodiments of the present disclosure, there is provided a solution for communication functionality validation. In this solution, a first apparatus (such as a testing equipment) receives, from a second apparatus (such as a rogue UE or a device under test (DUT)), a first performance metric of a first outcome of a communication functionality based on a first set of communication parameters and a reference performance metric of a reference outcome of the communication functionality based on a set of reference communication parameters. The first apparatus then validates the communication functionality based on a threshold and a difference between the first performance metric and the reference performance metric.

In the way, the communication functionality particularly generalization of the communication functionality can be validated. In some example embodiments, the threshold for validating the communication functionality may be based on a difference or a similarity between the first set of communication parameters and the set of reference communication parameters. By using such threshold, the communication functionality validation can take both the performance metric difference and the communication parameter difference between the first set of communication parameters and the reference communication parameters into account. In this way, the generalization of the AI/ML based communication functionality or AI/ML enabled use case can be validated for different scenarios.

Example embodiments of the present disclosure will be described in detail below with reference to the accompanying drawings.

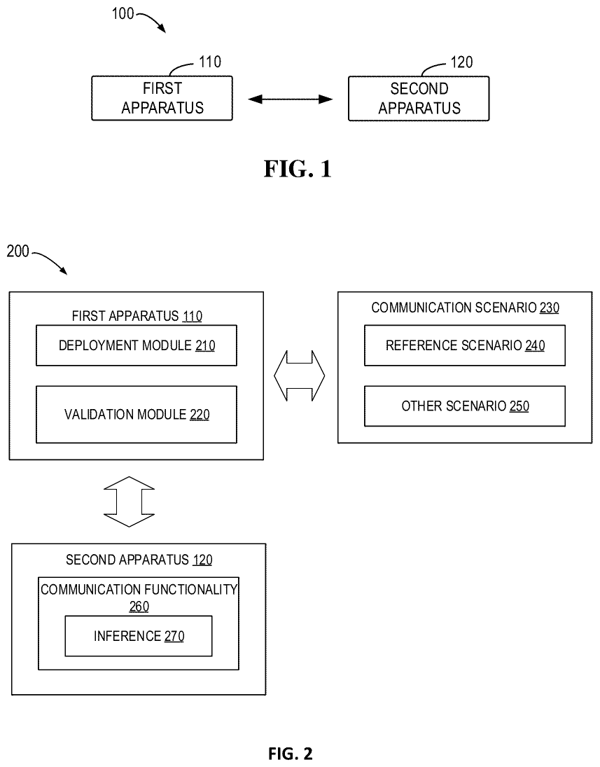

FIG. 1 illustrates an example communication environment 100 in which example embodiments of the present disclosure may be implemented. As shown in FIG. 1, the communication network 100 may include a first apparatus 110 and a second apparatus 120. The first apparatus 110 may communicate with the second apparatus 120. An AI/ML model may be deployed at the second apparatus 120. The AI/ML model may be used for any suitable use cases or to implement any suitable functionalities, for example but not limited to, channel state information (CSI) feedback enhancement, beam management (BM) (also referred to as beam prediction), positioning, etc. Monitoring or testing the performance of the AL/ML model may be needed.

It is to be understood that the number of second apparatus and first apparatus shown in FIG. 1 is given for the purpose of illustration without suggesting any limitations. The communication network 100 may include any suitable number of second apparatus and first apparatus.

In some example embodiments, the first apparatus 110 may include a test equipment (TE), and the second apparatus 120 may include a device under test (DUT). For example, an AI/ML model may be implemented at the second apparatus 120. Alternatively, a part of the AI/ML model may be implemented at the second apparatus 120. The AI/ML model (also referred to as a “model”) may provide a communication functionality.

As used herein, the term “communication functionality” may refer to a functionality or service provided by the AI/ML model. The term “communication functionality” may also be referred to as a “AI/ML based functionality” or “AI/ML enabled functionality” or “AI/ML based use case”. In some example embodiments, the AI/ML model at the second apparatus 120 may need to be tested or validated. In other words, the communication functionality may need to be tested or validated. For example, generalization of the communication functionality may need to be validated.

In some example embodiments, the first apparatus 110 may include a network device (for example, a gNB), and the second apparatus 120 may include a terminal device (for example, a UE). For example, the performance of the AI/ML model may need to be monitored.

In the following, for the purpose of illustration, some example embodiments are described with the first apparatus 110 operating as a network device and the second apparatus 120 operating as a terminal device. However, in some example embodiments, operations described in connection with a terminal device may be implemented at a network device or other device, and operations described in connection with a network device may be implemented at a terminal device or other device.

In some example embodiments, if the first apparatus 110 is a network device and the second apparatus 120 is a terminal device, a link from the second apparatus 120 to the first apparatus 110 is referred to as an uplink (UL), and a link from the first apparatus 110 to the second apparatus 120 is referred to as a downlink (DL). In UL, the second apparatus 120 is a transmitting (TX) device (or a transmitter) and the first apparatus 110 is a receiving (RX) device (or a receiver). In DL, the first apparatus 110 is a TX device (or a transmitter) and the second apparatus 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

FIG. 2 illustrates an example block diagram 200 for communication functionality validation according to some example embodiments of the present disclosure. As illustrated, the first apparatus 110 and the second apparatus 120 are deployed in the block diagram 200. The first apparatus 110 may include a deployment module 210 and a validation module 220. The deployment module 210 may be configured to run or simulate communication parameters such as conditions and/or configurations, to deploy a scenario. For example, a communication scenario 230 may be determined or simulated by the deployment module 210.

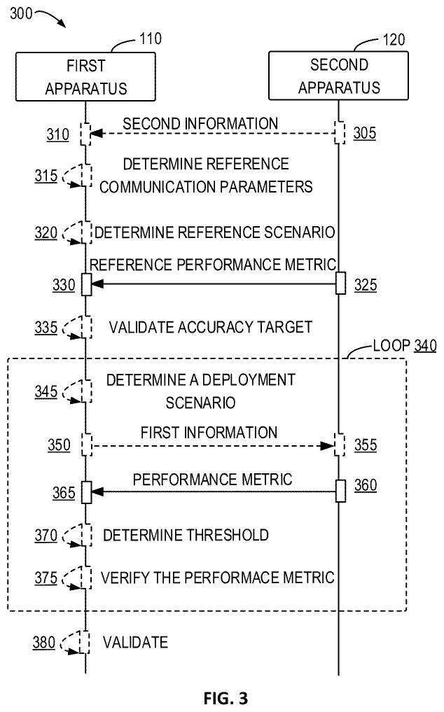

The communication scenario 230 may include one or more reference scenario(s) 240 and one or more other scenario(s) 250. The one or more reference scenarios 240 may be determined by the deployment module 210 based on one or more sets of reference communication parameters. The one or more other scenarios 250 (also referred to as candidate scenario) may be determined by the deployment module 210 based on one or more sets of (other) communication parameters (also referred to as candidate communication parameters). Details regarding the reference communication parameters and candidate communication parameters will be described with respect to FIG. 3.

In some example embodiments, the validation module 220 may be configured to validate a communication functionality 260 associated with the second apparatus 120. For example, the validation module 220 may validate generalization of the communication functionality 260. The communication functionality 260 may be performed by an AI/ML model implemented at the second apparatus 120. In the illustrated example, the communication functionality 260 may include an AI/ML based beam management (BM), an AI/ML based CSI feedback enhancement, an AI/ML based positioning, and/or the like. An outcome of the communication functionality 260 may be an inference 270 of the AI/ML model.

By using the block diagram 200, the reference conditions and configurations may be tested by using the first apparatus 110 and the accuracy target for selected key performance indicator (KPI) (such as beam prediction accuracy) can be validated.

Then, different other scenarios 250, which may be the combination of different conditions and/or configurations may be tested. The scenarios 250 may be a predefined scenario list in the specifications, or may be configured by the first apparatus 110. The first apparatus 110 may verify each scenario with a corresponding threshold (also referred to as a tolerance margin) associated with the selected scenario. If the performance metrics (also referred to as performance results) for all these various scenarios are met the corresponding thresholds (that is, within the corresponding tolerance margins) for these scenarios, then the generalization aspect may be considered validated. Details regarding the threshold or tolerance margin will be described with respect to FIG. 3.

It is to be understood that the present disclosure needs not be specific to beam management or beam prediction, which is taken as an example here, but can also be used for other use cases such as CSI feedback enhancement, positioning, and/or the like.

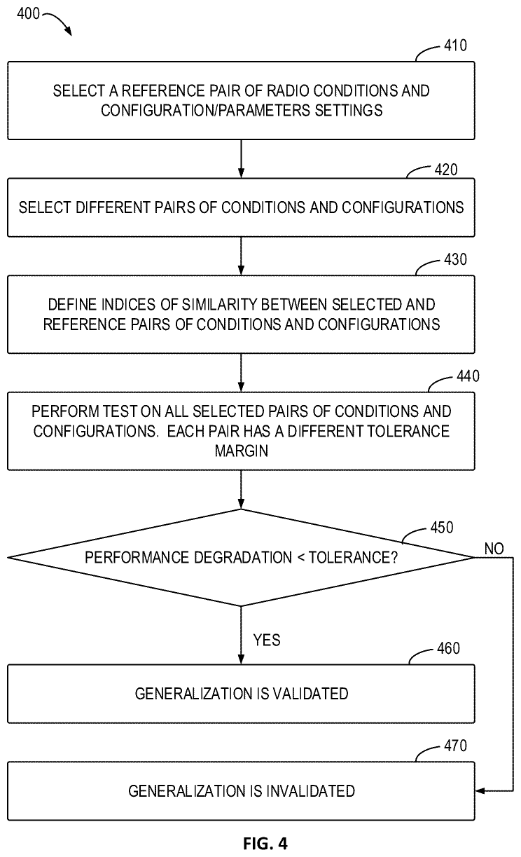

Example embodiments of the communication functionality validation have been described with respect to FIG. 2, which will be described in detail with respect to FIG. 3 and FIG. 4 below.

Reference is now made to FIG. 3, which illustrates a signaling chart 300 for communication functionality validation according to some example embodiments of the present disclosure. As shown in FIG. 3, the signaling chart 300 involves the first apparatus 110 and the second apparatus 120. The signaling chart 300 may be applicable for any suitable AI/ML use cases or any suitable communication functionalities. For example, various communication functionalities may include but not limited to CSI feedback enhancement, beam management, positioning, etc. In the following, some example embodiments are described by taking the beam prediction as an example. However, it is to be understood that this is merely an example without any limitation, and the concept described with respect the beam prediction may be applied to another AI/ML based communication functionalities or use cases.

For purpose of discussion, reference is made to FIG. 1 to describe the signaling chart 300. As shown in FIG. 3, the second apparatus 120 transmits (325) a reference performance metric to the first apparatus 110. The first apparatus 110 receives (330) the reference performance metric. As used herein, the term “performance metric” or “performance result” may refer to a metric for evaluating an outcome of the communication functionality. For example, the performance metric may be a KPI such as an accuracy of prediction, or the like.

In some example embodiments, the first apparatus 110 may determine (315) a set of reference communication parameters. The first apparatus 110 may determine (320) or run the reference deployment scenario (also referred to as a reference scenario) of the communication functionality based on the set of reference communication parameters.

The first apparatus 110 may then transmit information related to the reference deployment scenario to the second apparatus 120. As used herein, information related to the reference deployment scenario may be referred to as “third information”. By way of example, the third information may include a request for the reference performance metric. In some example embodiments, the second apparatus 120 may transmit (325) the reference performance metric to the first apparatus 110 in response to the third information. The first apparatus 110 may validate (335) the accuracy target based on the received (330) reference performance metric.

In some example embodiments, the first apparatus 110 may determine (315) the set of reference communication parameters based on one or more predefined sets of reference communication parameters. Alternatively, or in addition, the first apparatus 110 may determine (315) the set of reference communication parameters based on information from the second apparatus 120. For example, the second apparatus 120 may transmit (305) second information related to the set of reference communication parameters to the first apparatus 110. As used herein, the information related to the set of reference communication parameters may be referred to as the “second information”. The first apparatus 110 may receive (310) the second information. The first apparatus 110 may determine (315) the set of reference communication parameters based on the second information.

By way of example, the second information may include a supported communication functionality and/or model identification (ID) based life cycle management (LCM). The second information may further include applicable conditions associated with the supported communication functionality. The applicable conditions may be included in the set of reference communication parameters. As used herein, the term “applicable condition” may refer to a condition for the applicability of the communication functionality. For example, the second apparatus 120 may inform the network about the applicable conditions for the usage for AI/ML based communication functionality. Reference conditions, in this case, may also be indicated as applicable conditions.

In some example embodiments, the second apparatus 120 may transmit (305) the supported functionality (ies)/model ID based LCM including their applicable conditions to the first apparatus 110. The first apparatus 110 may either select the reference communication parameters (corresponding to a reference scenario) based on the supported functionalities/model IDs based LCM conditions or on the predefined reference communication parameters (corresponding to a predefined scenario) in the specifications. scenario.

Based on the determined (315) reference communication parameters, the first apparatus 110 may determine (320) the reference scenario or configure the reference scenario and run the test for the performance metric with the reference scenario.

In some example embodiments, the second apparatus 120 transmits (360) a performance metric of an outcome of the communication functionality based on a set of communication parameters different from the set of reference communication parameters to the first apparatus 110. For example, the second apparatus 120 transmits (360) a first performance metric of a first outcome of the communication functionality based on a first set of communication parameters to the first apparatus 110. The first apparatus 110 receives (365) the first performance metric.

In some example embodiments, the first set of communication parameters may be predefined. By way of example, the first apparatus 110 may select the first set of communication parameters from a plurality of predefined sets of communication parameters associated with the communication functionality.

In some example embodiments, the first apparatus 110 may determine (345) a deployment scenario of the communication functionality based on the first set of communication parameters. For example, the first apparatus 110 may run or simulate the deployment scenario.

The first apparatus 110 may transmit (350), to the second apparatus 120, first information related to the deployment scenario. As used herein, the information related to the deployment scenario may be referred to as the “first information”. The second apparatus 120 may receive (355) the first information. By way of example, the first information may include a request for the first performance metric. That is, the first apparatus 110 may request the second apparatus 120 to perform inference and provide the first performance metric of the inference.

In some example embodiments, the second apparatus 120 may transmit (360) the first performance metric to the first apparatus 110 in response to receiving (355) the first information. The first apparatus 110 may receive (365) the first performance metric. For example, the second apparatus 120 may perform inference and provide the first performance metric and optionally the inference (such as beam prediction accuracy or the predicted beam ID) to the first apparatus 110. In some example embodiments, the second apparatus 120 may transmit the inference to the first apparatus 110. The first apparatus 110 may itself determine the first performance metric based on the inference.

As briefly discussed, the reference communication scenario may be determined (320) based on the set of reference communication parameters, and the deployment scenario may be determined (345) based on another set of communication parameters such as the first set of communication parameters. In some example embodiments, the communication parameter may be related to a radio condition. Alternatively, or in addition, in some example embodiments, the communication parameter may be related to a communication configuration associated with the communication functionality. For example, if the communication functionality is a beam management, the communication configuration may be a configuration of a beam set or a configuration of a grid of beam.

By way of example, the reference radio condition may include but not limited to an additive white gaussian noise (AWGN) propagation condition or a pedestrian scenario in urban macro conditions, or any other radio condition scenario significantly present in the field.

The first set of communication parameters may be related to different radio conditions profile for testing. These radio conditions may be predefined or selected. For example, these radio condition may be a selection from most present scenarios in the field or from the standardized propagation modes. For instance, example radio conditions may include but not limited to tapped delay line (TDL)-A and/or TDL-C propagation conditions or scenarios with different speed in urban/rural macro/micro conditions.

In some example embodiments, the first set of communication parameters may be related to the communication configuration associated with the communication functionality such as a configuration or parameter of a beam set or a configuration of a grid of beam. The first set of communication parameters may include different configuration/parameters defined or selected for testing, including but not limited to a selection of beam set configuration from different network vendors, different grid of beam configurations and different number of narrow and wide beams.

Several example communication parameters have been described. It is to be understood that the communication parameter may include any other suitable condition or parameters. Example of the communication parameter may include but not limited to: an urban macro (UMa) propagation condition, an urban micro (UMi) propagation condition, 200 m inter-site distance (ISD) or 500 m ISD, same deployment, different cells with different configuration/assumption, carrier f frequencies, various outdoor/indoor distributions of the second apparatus 120 (or UE distributions) (e.g., 100%/0%, 20%/80%, and others), various mobility of the second apparatus 120 (such as [3 km/h], 30 km/h, 60 km/h and others), other parameters of the second apparatus 120 such as Rx beam codebook/panels of the second apparatus 120, antenna array dimensions of the second apparatus 120, various gNB settings, such as DL Tx beam codebook, various Set A of beam (pairs) or gNB antenna array dimensions, various Set B of beam (pairs), and/or the like.

The impact of generalization on the performance of various communication functionalities or AI/ML use cases (each use case configured with different AI/ML functionality/model) may depend heavily on the configuration and parameter settings used for dataset generation for the training. For example, for AI/ML beam management use-case, the communication parameters such as configurations may cover different beam sets/codebooks used, number of wide/narrow beams, grid of beam configuration etc. Similarly, the communication parameters may include parameters settings such as different sweeping frequency of the beams, the power settings, etc.

Statistically, it is possible to find the most present conditions/configurations in the field. This may be helpful in selecting a reference condition/configuration. Therefore, in some example embodiments, the reference communication parameters may be determined (315) by the first apparatus 110 based on the most present conditions or configurations in the field.

With the reference performance metric and the first performance metric, the first apparatus 110 may validate (380) the communication functionality. In some example embodiments, the first apparatus 110 may validate (380) the communication functionality based on a threshold and a first difference between the first performance metric and the reference performance metric. As used herein, the difference between a certain performance metric and the reference performance metric may be referred to as a “performance degradation” or “performance difference”.

In some example embodiments, the threshold may be predefined or configured. Alternatively, or in addition, in some example embodiments, the first apparatus 110 may determine (370) the threshold based on a second difference between the first set of communication parameters and the set of reference communication parameters. For example, the first apparatus 110 may determine a similarity such as an index of similarity between the first set of communication parameters and the set of reference communication parameters. The index of similarity may reflect the second difference. That is, the first apparatus 110 may identify the similarities between selected and reference pairs of conditions determining the second difference (e.g., with an algorithm implemented at the first apparatus 110) of a given pair of conditions and configurations compared to the reference pair of conditions and configurations. It is to be understood that the first apparatus 110 may also use other parameter such as a distance to represent the second difference. Scope of the present disclosure is not limited in this regard.

In some example embodiments, a larger second difference or a lower similarity may lead to a larger threshold (also referred to as a tolerance margin or a tolerance level). Likewise, a smaller second difference or a larger similarity may lead to a smaller threshold. The first apparatus 110 may determine thresholds for all combinations of conditions and configurations depending upon how different a given pair of conditions and configurations forms the reference pair of conditions and configurations.

By way of example, the second apparatus 120 may experience various degree of variations from the reference condition/configuration in the field. Therefore, in order to ensure that the second apparatus 120 performs within the tolerated margins, and different conditions and configurations may be tested and validated in RAN4, it needs to define different tolerance margins for different conditions/configurations depending upon how different these conditions/configurations are from the reference condition/configuration. In this way, the validation can be more accurate and reliable.

Alternatively, or in addition, in some example embodiments, the first apparatus 110 may obtain the threshold by fetching it from a predefined table. The predefined table may be determined based on the differences or the similarities between a plurality of sets of communication parameters and the reference communication parameters. For example, the predefined thresholds may depend on how different the selected scenario is from the reference scenario. Table 1 and Table 2 below show thresholds for several scenarios based on different sets of communication parameters.

TABLE 1
Thresholds

| | Normal radio | | |
|---|---|---|---|
| | conditions | Extreme good | Extreme bad |
| | (reference) | conditions | conditions |
| AWGN | 0% | 2% | 4% |
| TDL-A (30 ns delay | 3% | 4% | 6% |
| spread, 5 Hz) | | | |
| TDL-C (300 ns delay | 5% | 6% | 8% |
| spread, 100 Hz) | | | |

In Table 1, the reference scenario corresponds to normal radio conditions and AWGN. Different thresholds may be determined for other scenarios with difference conditions.

TABLE 2
Thresholds

| | Reference | | |
|---|---|---|---|
| | parameters | Parameters set 1 | Parameters set 2 |
| Reference beam set | 0% | 2% | 4% |
| Beam set 1 | 3% | 4% | 6% |
| Beam set 2 | 5% | 6% | 8% |

In Table 2, the reference scenario corresponds to reference parameters and reference beam set. Different thresholds may be determined for other scenarios with difference parameter set and/or different beam set.

In some example embodiments, if the first apparatus 110 verifies (375) the first performance metric and determines that the first difference is greater than or equal to the threshold, the first apparatus 110 may determine that generalization of the communication functionality is invalidated (380). As used herein, if a difference between a certain performance metric and the reference performance metric is greater than or equal to a respective threshold, the certain performance metric may be referred to as a performance metric being not met the threshold or not met the tolerance margin.

Alternatively, or in addition, in some example embodiments, if the first apparatus 110 verifies (375) the first performance metric and determines that the first difference is less than the threshold, the first apparatus 110 may determine that the first performance metric is verified (375). As used herein, if a difference between a certain performance metric and the reference performance metric is less than a respective threshold, the certain performance metric may be referred to as a performance metric being met the threshold or met the tolerance margin.

In some example embodiments, the first apparatus 110 may further verify (375) a second performance metric of a second outcome of the communication functionality based on a second set of communication parameters. For example, the first apparatus 110 may receive the second performance metric from the second apparatus 120. The first apparatus 110 may verify (375) the second performance metric based on a difference between the second performance metric and the reference performance metric and based on a second threshold associated with the second set of communication parameters. The first apparatus 110 may further validate (380) the communication functionality based on the verification (375) of the second performance metric.

In some example embodiments, a loop 340 may be performed by the first apparatus 110 and the second apparatus 120. That is, the first apparatus 110 may determine (345) different deployment scenarios for different sets of communication parameters. For example, in the loop 340, the first apparatus 110 may select one by one a scenario from the selected/predefined list of scenarios and run the performance test for the selected scenario.

The first apparatus 110 may obtain different performance metrics corresponding to the different scenarios. The first apparatus 110 may determine (370) respective thresholds for these sets of communication parameters. The first apparatus 110 may verify (375) each performance metric based on a respective threshold. For example, the second apparatus 120 may perform test on all selected combinations and report results to the first apparatus 110 such as a performance validation entity.

The first apparatus 110 may validate the tests based on the defined tolerance margins for different combinations. If the performance metrics for selected/predefined scenarios are within the tolerance margins, then the generalization aspects for AI/ML based BM may be considered validated otherwise it is not validated.

Based on the verification (375) of the different performance metrics, the first apparatus 110 may validate (380) the communication functionality. For example, if all the performance metrics are verified (375), that is, all the performance metrics are met respective thresholds, the first apparatus 110 may determine that the generalization of the communication functionality is validated (380). Otherwise, if a certain performance metric is not verified (375), the first apparatus 110 may determine that the generalization of the communication functionality is invalidated (380).

Alternatively, in some example embodiments, if the number of the verified (375) performance metrics is greater than or equal to a predefined or configured threshold number, the generalization of the communication functionality is validated (380). For example, if a majority of the performance metrics are met the respective thresholds, the generalization of the communication functionality is validated (380).

In this way, the communication functionality such as the generalization of the communication functionality can be validated. With the validation, it can guarantee that the AI/ML based communication functionality may work with acceptable accuracy for different conditions and configurations. A more robust system can thus be achieved which may be followed by an in-field performance monitoring mechanism.

Several example embodiments for communication functionality validation have been described with respect to FIG. 2 and FIG. 3. To better understand the solution of the present disclosure, further example embodiments are now described with FIG. 4, which illustrates an example process 400 for communication functionality validation according to some example embodiments of the present disclosure. The process 400 may be implemented by the first apparatus 110.

At block 410, the first apparatus 110 may select a reference pair of radio conditions and configuration/parameters settings. Example of reference radio condition may be an AWGN propagation condition or a pedestrian scenario in urban macro conditions, or any other radio condition scenario significantly present in the field.

Example of reference configuration may be a certain (selected/mutually agreed) beam set, number of wide/narrow beams, grid of beam configuration. The example of reference parameters setting would be a certain (selected/mutually agreed) sweeping frequency of the beams and the power settings etc. Reference configuration may be identified while reporting conditions assigned to each supported functionalities/model IDs. As such, reference configuration may be a certain condition corresponding to supported functionalities/model IDs.

The principle of selection of reference conditions/configuration may be to select conditions that are either generally tested in RAN4 verification (such as AWGN conditions) or the conditions which are mainly encountered by the second apparatus 120 in the field after deployment (such as a slow-moving UE in macro urban conditions).

At block 420, the first apparatus 110 may select different pairs of conditions and configurations. For example, the first apparatus 110 may define or select different radio conditions profile for testing. This may be a selection from most present scenarios in the field or from the standardized propagation modes, for instance, TDL-A and/or TDL-C propagation conditions or scenarios with different speed in urban/rural macro/micro conditions. For example, the first apparatus 110 may define or select different configuration/parameters for testing. This may be a selection of beam set configuration from different network vendors, different grid of beam configurations and different number of narrow and wide beams.

In some example embodiments, there may be a predefined list of scenarios with a variety of conditions and configurations. These scenarios may be a combination of generally tested conditions in RAN4 such as TDL-A, TDL-C channel conditions with changing parameters to calibrate normal and extreme radio conditions. The list of scenarios may also be influenced by the most present scenario in the field such as slow moving UEs/high speed UEs in micro/macro urban/rural conditions.

In the following description, the example of types of propagation models such as AWGN, TDL-A, TDL-C with static, slow moving and high speed UEs may be used. For example, AWGN with static conditions may be selected as the reference conditions for the sake of clarity and simplicity. It is to be understood that this remains just an example.

At block 430, the first apparatus 110 may define indices of similarity between selected and reference pairs of conditions and configurations. For example, the first apparatus 110 may identify the similarities between selected and reference pairs of conditions determining the difference (e.g., with an algorithm implemented at the first apparatus 110) of a given pair of conditions and configurations compared to the reference pair of conditions and configurations.

At block 440, the first apparatus 110 may perform test on each selected pair of conditions and configurations. Each pair has a different tolerance margin. For example, the first apparatus 110 may define tolerance margin for each combination of conditions and configurations depending upon how different a given pair of conditions and configurations forms the reference pair of conditions and configurations.

If assuming that the beam prediction accuracy target for the reference conditions/configuration is 95% of correctly predicted beams, i.e., the best predicted beam matches the ground truth best beam (where “matches” may mean the RSRP of the best predicted beam is within e.g., 1 dB of the RSRP of the ground truth best beam). Then Table 1 above depicts different tolerance margins for different scenarios depending how close they are from the reference conditions.

Alternative conditions that are used in testing may be selected relative to the reference conditions. For example, if the model was originally trained in rural pedestrian conditions, then vehicular conditions might be already extreme for it. However, if the model was used train for rural pedestrian and vehicular conditions then urban conditions may be considered as extreme for it.

Likewise, a reference beam set m be selected together with the other reference parameter setting. Subsequently, various configurations may be defined in the specifications having different beam sets and different parameters settings. Depending upon how close these beam sets and parameters are from the reference beam set and reference parameter settings, different tolerance margin may be specified for different combinations. Table 2 above depicts different tolerance margins for different configurations depending how close they are from the reference configuration.

At block 450, the first apparatus 110 may determine whether the performance degradation is less than the tolerance margin. The performance degradation may refer to the difference between the performance metric and the reference performance metric. In some example embodiments, the performance metric may be a performance KPI. For example, the performance KPI(s) may be beam prediction accuracy.

The performance KPIs, such as beam prediction accuracy for the reference conditions/configuration, may be defined as a target in RAN4 specifications and it will be part of the performance requirement testing of the AI/ML based BM use case. For the validation of generalization aspects, it is not sufficient to only validate performance KPIs for a given condition/configuration and therefore, it is necessary to test and validate AI/M based BM use case for a variety of conditions and configurations.

Furthermore, a discussion on applicable conditions is currently ongoing in RAN1, where the second apparatus 120 may inform the network about the applicable conditions for the usage for AI/ML based solution. Reference conditions, in this case, may also be indicated as applicable conditions.

In some example embodiments, if the performance degradation is less than the tolerance margin, at block 460, the first apparatus 110 may determine that the generalization for the current set of communication parameters is validated. Otherwise, if the performance degradation is greater than or equal to the tolerance margin, at block 470, the first apparatus 110 may determine that the generalization of the communication functionality for the current communication parameters is invalidated.

By using the process 400, the AI/ML based communication functionality such as beam management can be tested for various other conditions/configuration. In this manner, generalization aspects of the AI/ML based solutions such as the generalization of the communication functionality can be validated.

Several example embodiments have been described with respect to FIG. 2 to FIG. 4. It is to be understood that these example embodiments can be used in any suitable combination, or used separately. It is to be noted that FIG. 2 to FIG. 4 illustrate the communication functionality of beam management or beam prediction as an example. The concept described above may be applicable to other communication functionalities or use cases, for example, CSI feedback enhancement, positioning, etc.

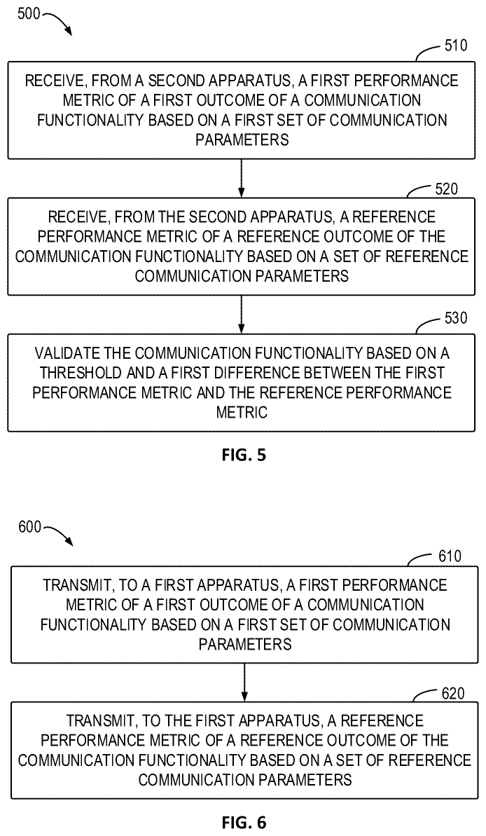

FIG. 5 shows a flowchart of an example method 500 implemented at a first apparatus in accordance with some example embodiments of the present disclosure. For the purpose of discussion, the method 500 will be described from the perspective of the first apparatus 110 in FIG. 1.

At block 510, the first apparatus 110 receives, from a second apparatus, a first performance metric of a first outcome of a communication functionality based on a first set of communication parameters.

At block 520, the first apparatus 110 receives, from the second apparatus, a reference performance metric of a reference outcome of the communication functionality based on a set of reference communication parameters.

At block 530, the first apparatus 110 validates the communication functionality based on a threshold and a first difference between the first performance metric and the reference performance metric.

In some example embodiments, the method 500 further comprises: determining a deployment scenario of the communication functionality based on the first set of communication parameters; transmitting, to the second apparatus, first information related to the deployment scenario; and receiving, from the second apparatus, the first performance metric in the deployment scenario.

In some example embodiments, the method 500 further comprises: selecting the first set of communication parameters from a plurality of predefined sets of communication parameters associated with the communication functionality.

In some example embodiments, the method 500 further comprises: receiving, from the second apparatus, second information related to the set of reference communication parameters; and determining the set of reference communication parameters based on the second information.

In some example embodiments, the method 500 further comprises: determining a reference deployment scenario of the communication functionality based on the set of reference communication parameters; transmitting, to the second apparatus, third information related to the reference deployment scenario; and receiving, from the second apparatus, the reference performance metric in the reference deployment scenario.

In some example embodiments, the method 500 further comprises: determining the threshold based on a second difference between the first set of communication parameters and the set of reference communication parameters.

In some example embodiments, the communication parameter is related to at least one of: a radio condition, a communication configuration associated with the communication functionality.

In some example embodiments, the method 500 further comprises: in accordance with a determination that the first difference is greater than or equal to the threshold, determining that generalization of the communication functionality is invalidated.

In some example embodiments, the method 500 further comprises: in accordance with a determination that the first difference is less than the threshold, receiving, from the second apparatus, a second performance metric of a second outcome of the communication functionality based on a second set of communication parameters; and validating the communication functionality further based on at least the second performance metric.

In some example embodiments, the communication functionality comprises beam management.

FIG. 6 shows a flowchart of an example method 600 implemented at a second apparatus in accordance with some example embodiments of the present disclosure. For the purpose of discussion, the method 600 will be described from the perspective of the second apparatus 120 in FIG. 1.

At block 610, the second apparatus 120 transmits, to a first apparatus, a first performance metric of a first outcome of a communication functionality based on a first set of communication parameters; and

At block 620, the second apparatus 120 transmits, to the first apparatus, a reference performance metric of a reference outcome of the communication functionality based on a set of reference communication parameters.

In some example embodiments, the method 600 further comprises: receiving, from the first apparatus, first information related to a deployment scenario of the communication functionality based on the first set of communication parameters; and in response to receiving the first information, transmitting, to the first apparatus, the first performance metric in the deployment scenario.

In some example embodiments, the method 600 further comprises: transmitting, to the first apparatus, second information related to the set of reference communication parameters.

In some example embodiments, the method 600 further comprises: receiving, from the first apparatus, third information related to a reference deployment scenario of the communication functionality based on the set of reference communication parameters; and in response to receiving the third information, transmitting, to the first apparatus, the reference performance metric in the reference deployment scenario.

In some example embodiments, the communication functionality comprises beam management.

In some example embodiments, a first apparatus capable of performing any of the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a first performance metric of a first outcome of a communication functionality based on a first set of communication parameters; means for receiving, from the second apparatus, a reference performance metric of a reference outcome of the communication functionality based on a set of reference communication parameters; and means for validating the communication functionality based on a threshold and a first difference between the first performance metric and the reference performance metric.

In some example embodiments, the first apparatus further comprises: means for determining a deployment scenario of the communication functionality based on the first set of communication parameters; means for transmitting, to the second apparatus, first information related to the deployment scenario; and means for receiving, from the second apparatus, the first performance metric in the deployment scenario.

In some example embodiments, the first apparatus further comprises: means for selecting the first set of communication parameters from a plurality of predefined sets of communication parameters associated with the communication functionality.

In some example embodiments, the first apparatus further comprises: means for receiving, from the second apparatus, second information related to the set of reference communication parameters; and means for determining the set of reference communication parameters based on the second information.

In some example embodiments, the first apparatus further comprises: means for determining a reference deployment scenario of the communication functionality based on the set of reference communication parameters; means for transmitting, to the second apparatus, third information related to the reference deployment scenario; and means for receiving, from the second apparatus, the reference performance metric in the reference deployment scenario.

In some example embodiments, the first apparatus further comprises: means for determining the threshold based on a second difference between the first set of communication parameters and the set of reference communication parameters.

In some example embodiments, the communication parameter is related to at least one of: a radio condition, a communication configuration associated with the communication functionality.

In some example embodiments, the first apparatus further comprises: means for in accordance with a determination that the first difference is greater than or equal to the threshold, determining that generalization of the communication functionality is invalidated.

In some example embodiments, the first apparatus further comprises: means for in accordance with a determination that the first difference is less than the threshold, receiving, from the second apparatus, a second performance metric of a second outcome of the communication functionality based on a second set of communication parameters; and means for validating the communication functionality further based on at least the second performance metric.

In some example embodiments, the communication functionality comprises beam management.

In some example embodiments, the first apparatus further comprises means for performing other operations in some example embodiments of the method 500 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second apparatus 120 in FIG. 1 may comprise means for performing the respective operations of the method 600. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a first performance metric of a first outcome of a communication functionality based on a first set of communication parameters; and means for transmitting, to the first apparatus, a reference performance metric of a reference outcome of the communication functionality based on a set of reference communication parameters.

In some example embodiments, the second apparatus further comprises: means for receiving, from the first apparatus, first information related to a deployment scenario of the communication functionality based on the first set of communication parameters; and means for in response to receiving the first information, transmitting, to the first apparatus, the first performance metric in the deployment scenario.

In some example embodiments, the second apparatus further comprises: means for transmitting, to the first apparatus, second information related to the set of reference communication parameters.

In some example embodiments, the second apparatus further comprises: means for receiving, from the first apparatus, third information related to a reference deployment scenario of the communication functionality based on the set of reference communication parameters; and means for in response to receiving the third information, transmitting, to the first apparatus, the reference performance metric in the reference deployment scenario.

In some example embodiments, the communication functionality comprises beam management.

In some example embodiments, the second apparatus further comprises means for performing other operations in some example embodiments of the method 600 or the second apparatus 120. In some example embodiments, the means comprises at least one processor; and at least one memory storing instructions that, when executed by the at least one processor, cause the performance of the second apparatus.

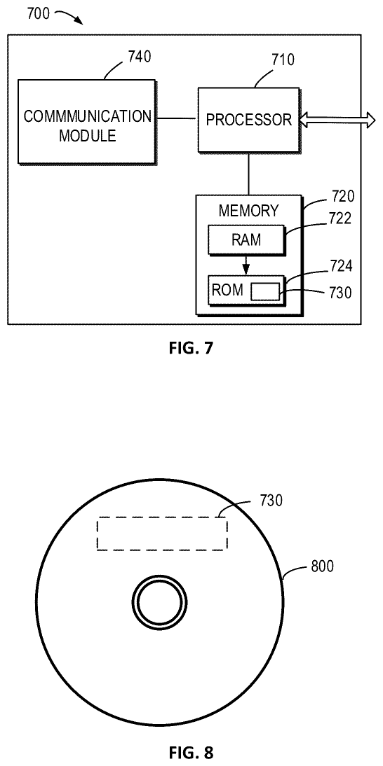

FIG. 7 is a simplified block diagram of a device 700 that is suitable for implementing example embodiments of the present disclosure. The device 700 may be provided to implement a communication device, for example, the first apparatus 110 or the second apparatus 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-20. (canceled)

21. A first apparatus comprising:
at least one processor; and
at least one memory storing instructions that, when executed by the at least one processor, cause the first apparatus to:
receive, from a second apparatus, a first performance metric of a first outcome of a communication functionality based on a first set of communication parameters, wherein the communication functionality comprises beam management;
determine a deployment scenario of the communication functionality based on the first set of communication parameters;
transmit, to the second apparatus, information related to the deployment scenario;
based on the information, receive, from the second apparatus, a reference performance metric of a reference outcome of the communication functionality based on a set of reference communication parameters; and
validate the communication functionality based on a threshold and a first difference between the first performance metric and the reference performance metric.

22. The first apparatus of claim 21, wherein the first apparatus is caused to:
select the first set of communication parameters from a plurality of predefined sets of communication parameters associated with the communication functionality.

23. The first apparatus of claim 22, wherein the first apparatus is caused to:
receive, from the second apparatus, second information related to the set of reference communication parameters; and
determine the set of reference communication parameters based on the second information.

24. The first apparatus of claim 23, wherein the first apparatus is caused to:
determine the threshold based on a second difference between the first set of communication parameters and the set of reference communication parameters.

25. The first apparatus of claim 24, wherein a communication parameter in the first set of communication parameters is related to a radio condition and a communication configuration associated with the communication functionality.

26. The first apparatus of any claim 25, wherein the first apparatus is caused to:
in accordance with a determination that the first difference is greater than or equal to the threshold, determine that generalization of the communication functionality is invalidated.

27. The first apparatus claim 25, wherein the first apparatus is caused to:
in accordance with a determination that the first difference is less than the threshold, receive, from the second apparatus, a second performance metric of a second outcome of the communication functionality based on a second set of communication parameters; and
validate the communication functionality further based on at least the second performance metric.

28. A system comprising:
a first apparatus;
at least one processor; and
at least one memory storing instructions that, when executed by the at least one processor, cause the first apparatus to:
receive, from a second apparatus, a first performance metric of a first outcome of a communication functionality based on a first set of communication parameters, wherein the communication functionality comprises beam management;
determine a deployment scenario of the communication functionality based on the first set of communication parameters;
transmit, to the second apparatus, information related to the deployment scenario;
based on the information, receive, from the second apparatus, a reference performance metric of a reference outcome of the communication functionality based on a set of reference communication parameters; and
validate the communication functionality based on a threshold and a first difference between the first performance metric and the reference performance metric.

29. The system of claim 28, wherein the first apparatus is caused to:
select the first set of communication parameters from a plurality of predefined sets of communication parameters associated with the communication functionality.

30. The system of claim 29, wherein the first apparatus is caused to:
receive, from the second apparatus, second information related to the set of reference communication parameters; and
determine the set of reference communication parameters based on the second information.

31. The system of claim 30, wherein the first apparatus is caused to:
determine the threshold based on a second difference between the first set of communication parameters and the set of reference communication parameters.

32. The system of claim 31, wherein a communication parameter in the first set of communication parameters is related to a radio condition and a communication configuration associated with the communication functionality.

33. The system of any claim 32, wherein the first apparatus is caused to:
in accordance with a determination that the first difference is greater than or equal to the threshold, determine that generalization of the communication functionality is invalidated.

34. The system claim 32, wherein the first apparatus is caused to:
in accordance with a determination that the first difference is less than the threshold, receive, from the second apparatus, a second performance metric of a second outcome of the communication functionality based on a second set of communication parameters; and
validate the communication functionality further based on at least the second performance metric.

35. A method comprising:
receiving, by a first apparatus from a second apparatus, a first performance metric of a first outcome of a communication functionality based on a first set of communication parameters, wherein the communication functionality comprises beam management;
determining a deployment scenario of the communication functionality based on the first set of communication parameters;
transmitting, to the second apparatus, information related to the deployment scenario;
based on the information, receive, from the second apparatus, a reference performance metric of a reference outcome of the communication functionality based on a set of reference communication parameters; and
validating the communication functionality based on a threshold and a first difference between the first performance metric and the reference performance metric.

36. The method of claim 35, further comprising:
selecting the first set of communication parameters from a plurality of predefined sets of communication parameters associated with the communication functionality.

37. The method of claim 36, further comprising:
receiving, from the second apparatus, second information related to the set of reference communication parameters; and
determining the set of reference communication parameters based on the second information.

38. The method of claim 37, further comprising:
determining the threshold based on a second difference between the first set of communication parameters and the set of reference communication parameters.

39. The method of claim 38, wherein a communication parameter in the first set of communication parameters is related to a radio condition and a communication configuration associated with the communication functionality.

40. The method of any claim 39, further comprising:
in accordance with a determination that the first difference is greater than or equal to the threshold, determining that generalization of the communication functionality is invalidated; or
in accordance with a determination that the first difference is less than the threshold:
receiving, from the second apparatus, a second performance metric of a second outcome of the communication functionality based on a second set of communication parameters; and
validating the communication functionality further based on at least the second performance metric.
